(19) United States
(12) Patent Application Publication
(10) Pub. No.: US 2008/0123379 A1
(43) Pub. Date: May 29, 2008

(54) Voltage Regulating Circuit

(75) Inventors: Pieter Jan Mark Smidt, Eindhoven (NL); Jorge Luiz Duarte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,786

(22) PCT Filed: Apr. 6, 2005
(86) PCT No.: PCT/IB05/51130

§ 371 Date: Oct. 10, 2006

(30) Foreign Application Priority Data
Apr. 13, 2004 (EP) 04101489.5

(51) Int. Cl. H02M 7/155; H02M 7/02

(52) U.S. Cl. 363/85; 363/84

(57) ABSTRACT

A voltage regulating circuit comprising a rectifier (2) for receiving an AC voltage (Vₘₐᵢₙₛ) and for generating a rectified AC voltage (v_{rec}), and a capacitor (3) connected in parallel with said rectified AC voltage for providing a DC voltage (V_{DC}) over a load (5), characterized by a unidirectional current switch (4) provided between the rectifier (2) and the capacitor (3), and a control block (6) arranged to activate the switch (4) at selected instances (7) during negative slopes of the rectified AC voltage (v_{rec}) so that said DC voltage (V_{DC}) does not exceed a predetermined voltage limit. By controlling the voltage provided by the rectified mains, the DC voltage can be regulated to any preset value (lower than the AC mains peak value). The inventive voltage stabilizer will guarantee a desired constant DC load voltage value for different mains peak input voltages and under wide range of load variations. Thereby a converter driven by this voltage can be more optimized or even be unregulated.

The present invention relates to a voltage regulating circuit comprising a rectifier for receiving an AC voltage and for generating a rectified AC voltage, and a capacitor connected in parallel with said rectified AC voltage for providing a DC voltage over a load.

Switch mode power supplies are normally operated from a rectified mains voltage. A relatively simple full bridge diode rectifier followed by a smoothing capacitor (usually an electrolytic capacitor or “elcap”) generates a rectified mains equal to the peak value of the sinusoidal mains voltage. Due to the variation in mains voltage in different regions (110Vac or 230Vac in most countries), the power supply following such a rectification circuit must be able to cope with a significant input voltage variation.

For a conventional flyback converter this is normally not a problem, but there is a large group of power supply topologies (e.g. so called resonant power supplies) that exhibit a cumbersome behavior when operating on full mains. For example, the amount of blind current circulating through the converter reaches such a high level that the efficiency is reduced to a low level, and power related components have to be very large. In order to overcome this problem, so called voltage double circuits can be used. In 230V countries the rectifier serves as a normal rectifier, in 110V countries the rectifier is reconfigured as a voltage doubler. The latter can be done by a simple wire in the factory or by an external switch. While a permanent wiring does not allow changing the setting, an extra switch is more expensive and involves the risk of selecting the wrong voltage. Another option is to select the voltage automatically with an electronic switch, usually a triac, which has to be controlled by some electronics, usually in the form of an IC. This type of solution is expensive and therefore very seldom used.

It is an object of the present invention to overcome this problem, and to provide a voltage regulating circuit which is inexpensive and simple to implement, and capable of driving different power supply topologies, including resonant power supplies.

This and other objects are achieved with a voltage regulating circuit of the kind mentioned by way of introduction, further comprising a unidirectional current switch provided between the rectifier and the capacitor, and a control block arranged to activate the switch at selected instances during negative slopes of the rectified AC voltage so that said DC voltage does not exceed a predetermined voltage limit.

By controlling the voltage provided by the rectified mains, the DC voltage cain be regulated to any preset value (lower than the AC mains peak value). The inventive voltage stabilizer will guarantee a desired constant DC load voltage value for different mains peak input voltages and under wide range of load variations. Thereby a converter driven by this voltage can be more optimized or even be unregulated.

The basic principle of the invention is to combine a standard rectifier bridge with a unidirectional current conduction switch. The moment at which the switch is switched on will determine the DC voltage on the capacitor. It is important that the switch is only turned on at the falling slope of the rectified mains, as otherwise a too high voltage will appear on the capacitor at high mains. It is noted that a current conduction switch is only turned off when its current is brought to zero.

The invention offers a simple and inexpensive way to provide input voltage regulation, and the problems with using resonant converters are thus reduced. Use of resonant converters can in turn lead to a more efficient, smaller and more cost effective power supply, especially for higher powers (e.g. audio power supplies, and (LCD) TV).

The control block can be arranged to receive one of the AC voltage or the rectified AC voltage together with the voltage over the load, in order to control the switch based on these voltage levels. By such feedback and feedforward of voltage levels, a very satisfactory control of the DC voltage may be obtained.

According to one preferred embodiment, the control block comprises means for generating a scaled version of the rectified AC voltage, means for generating a scaled version of the load voltage, means for generating a compensation signal, by integrating a difference between a reference voltage and said scaled load voltage, means for comparing said compensating signal and said scaled rectified AC voltage, and means for activating said switch each time the scaled rectified AC voltage falls below said compensating signal.

This embodiment offers a practical implementation of the invention, easy to realize with e.g. a plurality of operational amplifiers. The means for generating a compensating signal can comprise a proportional-integrator.

The rectifier can be a diode bridge rectifier, which is a component often used for rectifying an AC mains. The current conduction switch can be a thyristor, which is relatively inexpensive and simple to implement

This and other aspects of the present invention will now be described in more detail, with reference to the appended drawings showing a currently preferred embodiment of the invention.

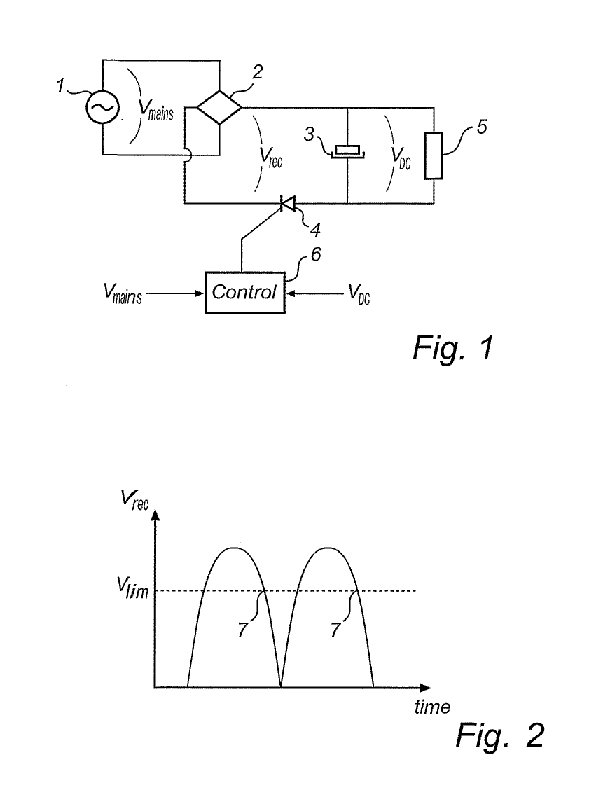

FIG. 1 is a schematic block diagram of a voltage regulating circuit according to an embodiment of the present invention.

FIG. 2 is a diagram of the rectified mains voltage, illustrating when the switch in FIG. 1 is switched ON in order to achieve a desired DC voltage.

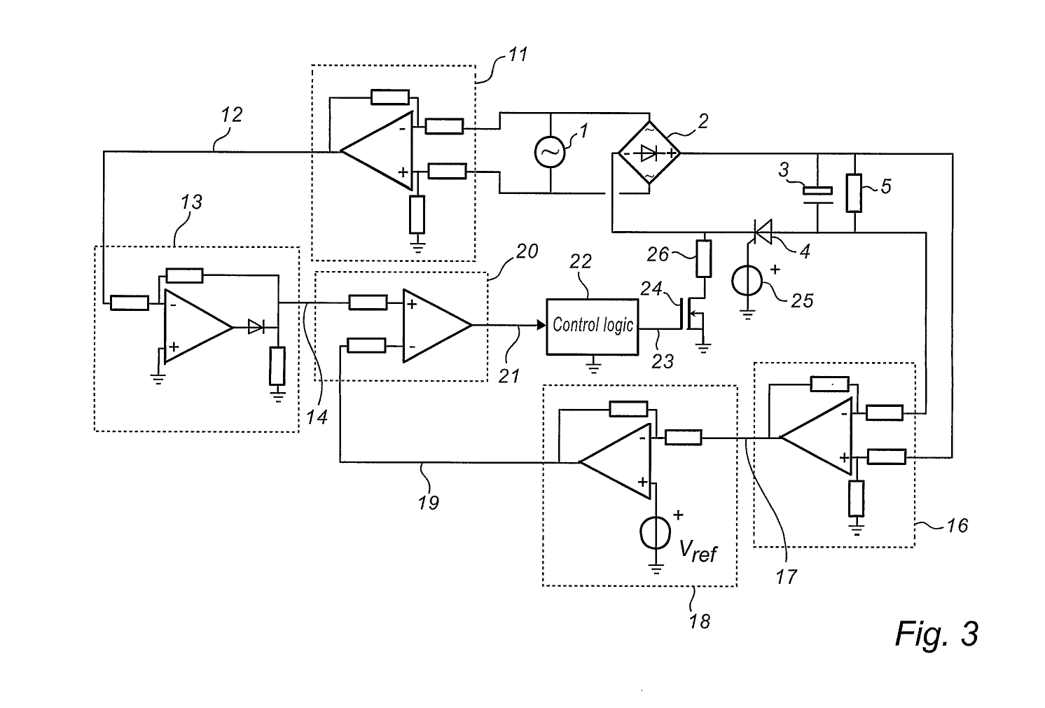

FIG. 3 is a more detailed circuit diagram of the voltage regulating circuit in FIG. 1.

The invention can be implemented with a basic design showed in FIG. 1. The circuit comprises a AC mains voltage supply 1, connected to a rectifier such as a diode rectifier bridge 2. The rectified voltage v_{rec} is connected to a “smoothing” capacitor, e.g. an electrolytic capacitor 3, via a current conduction switch, such as a thyristor 4, and the capacitor provides a load 5 with a DC voltage, v_{dc}. The switch is controlled by a control block 6, which is connected to the mains voltage vₘₐᵢₙₛ and to the voltage v_{dc} over the load, and provides a control signal for switching the switch in response to these voltage values.

The control block 6 is adapted to switch the thyristor 4 ON each time the rectified mains voltage v_{rec} passes a desired voltage limit vₗᵢₘ on its falling slope, indicated with reference 7 in FIG. 2. As a result, the elcap 3 is connected to the rectified mains from this moment until the rectified mains voltage v_{rec} has fallen to zero, at which point no current flows through the thyristor and it is consequently switched OFF. In other words, the elcap 3 is repeatedly connected to a voltage varying between the voltage limit vₗᵢₘ and zero, and will generate a smoothed DC voltage v_{DC} approximately equal to the voltage limit vₗᵢₘ. This limit can obviously be chosen at any level lower than the rectified mains peak voltage.

A more detailed diagram of the circuit in FIG. 1 is shown in FIG. 3. Mains power supply 1, rectifier bridge 2, elcap 3, thyristor 4 and load 5 have been given the same numerals as in FIG. 1, while the remaining elements all relate to the control block 6 in FIG. 1.

A differential measurement circuit 11 connected in parallel with the mains voltage vₘₐᵢₙₛ provides a sinusoidal signal 12 proportional to the mains voltage, and this signal is rectified in a rectifier 13 to produce a signal 14, which is a scaled version of the rectified mains v_{rec} provided by the rectifier bridge 2. A second differential measurement circuit 16, similar to circuit 11, is connected in parallel over the load 5, and provides a signal 17 proportional to the voltage v_{DC} over the load. The scaled signal 17 is compared to a reference voltage v_{ref} in a compensator 18, to produce a compensation signal 19 which is increased when the signal 17 is less than v_{ref}, and decreased when the signal 17 is greater than v_{ref}. The compensator can be a proportional-integral compensator.

A comparator 20 compares the scaled rectified mains 14 with the compensation signal 19 and produces an alternating output 21. This output 21 is connected to a control logic bock 22, which is arranged to generate trigger signals 23 (voltage pulses a few microseconds long) on the negative flanks of the output 21, i.e. at the instants when the scaled rectified mains 14 falls below the compensation signal 19. This ensures that the trigger signals 23 are only generated after the peak values of the mains voltage have already occurred.

These pulses 23 are applied to the gate of an auxiliary switch, here a transistor 24, which allows current to be drawn from an auxiliary voltage source 25 through the gate of the thyristor 4. The triggering current can be limited to an accurate value by means of extra impedance, for instance a resistance 26 connected between the transistor 24 and the thyristor 4. Note that the control circuit is floating (high impedant) from to the power circuit. Therefore, although the voltage source 25 is permanently connected to the thyristor gate, a current through the thyristor will only be generated (and thus the thyristor activated) when the switch 24 is closed.

The circuit in FIG. 3 will secure that power is transferred in a controlled way from the mains 1 to the load 5 through the diode rectifier 2. The electronic switch (thyristor 4) will regulate the necessary power to be delivered to the load 5, and thereby keep the DC voltage over the load at a constant level.

The person skilled in the art realizes that the present invention by no means is limited to the preferred embodiments described above. On the contrary, many modifications and variations are possible within the scope of the appended claims. For example, the blocks 11, 13, 16, 18 and 20, which have all been illustrated as implemented by operational amplifiers, may be implemented in a different way.

1. A voltage regulating circuit comprising a rectifier (2) for receiving an AC voltage (vₘₐᵢₙₛ) and for generating a rectified AC voltage (v_{rec}), and a capacitor (3) connected in parallel with said rectified AC voltage for providing a DC voltage (V_{DC}) over a load (5), characterized by a unidirectional current switch (4) provided between the rectifier (2) and the capacitor (3), and a control block (6) arranged to activate the switch (4) at selected instances (7) during negative slopes of the rectified AC voltage (v_{rec}) so that said DC voltage (V_{DC}) does not exceed a predetermined voltage limit (vₗᵢₘ).

2. A voltage regulating circuit according to claim 1, wherein said control block (6) is arranged to receive the AC voltage (vₘₐᵢₙₛ) or the rectified AC voltage (v_{rec}), and the voltage over the load (v_{DC}), in order to control the switch based on these voltage levels.

3. A voltage regulating circuit according to claim 2, wherein the control block comprises:
means (11, 13) for generating a scaled version (14) of the rectified AC voltage (v_{rec}),
means (16) for generating a scaled version (17) of the load voltage (V_{DC}),
means (18) for generating a compensation signal (19), by integrating a difference between a reference voltage (v_{ref}) and said scaled load voltage (17),
means (20) for comparing said compensating signal (19) and said scaled rectified AC voltage (14), and
means (22, 24, 25, 26) for activating said switch (4) each time the scaled rectified AC voltage (14) falls below said compensating signal (19).

4. A voltage regulating circuit according to claim 3, wherein said means (11, 13, 16) for generating scaled versions of the rectified mains and the load voltage comprise one or several operational amplifiers.

5. A voltage regulating circuit according to claim 3, wherein said means (18) for generating a compensating signal comprise a proportional-integrator.

6. A voltage regulating circuit according to claim 1, wherein said rectifier (2) is a diode bridge rectifier.

7. A voltage regulating circuit according to claim 1, wherein said unidirectional current switch (4) is a thyristor.
